(19) United States
(12) Patent Application Publication
(10) Pub. No.: US 2026/0328729 A1
(43) Pub. Date: Oct. 22, 2026

(54) METHOD AND SYSTEM FOR DETERMINING MATERIAL PROPERTY OF SAMPLE USING EDGE WAVEFRONT SIGNAL

(71) Applicant: INDIAN INSTITUTE OF TECHNOLOGY (IIT MADRAS), Chennai, Tamil Nadu (IN)

(72) Inventors: Krishnan BALASUBRAMANIAN, Chennai, Tamil Nadu (IN); Anoop UPENDRAN, Alappuzha, Kerala (IN)

(21) Appl. No.: 19/115,558

(22) PCT Filed: Sep. 25, 2023
(86) PCT No.: PCT/IN2023/050886

§ 371 Date: Mar. 26, 2025

(30) Foreign Application Priority Data
Sep. 26, 2022 (IN) 202241053059

(51) Int. Cl. G01N 29/06; G01N 29/22

(52) U.S. Cl. CPC G01N 29/0681; G01N 29/221

(57) ABSTRACT

The present invention describes an acoustic microscopy arrangement (400) for determining material property of a sample using edge wavefront signal. The arrangement (400) comprises a curved ultrasonic transducer (402) that is designed without apodization at boundaries. The system further comprises a control unit (406) configured to generate, using the excited curved ultrasonic transducer (402), an acoustic wavefront signal that includes an acoustic wavefront signal and receive a plurality of reflected acoustic wave signals from the sample for each of the adjusted defocus distance and generate information for each of the defocus distance based on the plurality of received reflect acoustic wave signals. Sequentially, the control unit is configured to analyze the information for each of the defocus distance to determine the material property of the sample.

The following specification particularly describes the invention and the manner in which it is to be performed.

### DESCRIPTION OF THE INVENTION

### Technical Field

The present invention generally relates to the field of Non-destructive evaluation and material characterization. In particular, the present invention is directed to a system and a method for determining material property of sample using edge wavefront signal.

### BACKGROUND

The following description includes information that may be useful in understanding the present invention. It is not an admission that any of the information provided herein is prior art or relevant to the presently claimed invention, or that any publication specifically or implicitly referenced is prior art.

Acoustic microscopy is extensively used in material characterization of both metallic and biological samples. In Acoustic microscopy-based defocusing approach surface waves are generated using a single transducer operating in pulse echo mode. The transducer is focused on the surface of the sample before the scan. Then a linear scan is performed by moving the transducer in a direction normal to the sample surface. A portion of transducer wavefront has normal incidence with the sample surface, this is known as specular reflection. The remaining portion of the transducer wavefront has an oblique incidence with the sample surface, as a result surface waves get generated on the sample. While the surface wave propagates along the sample surface, a portion of the energy leaks back into the coupling fluid, which is received by the transducer. The interference of the surface wave and the specular reflection is used to find the surface wave velocity. The maximum angle of incidence possible by a particular transducer is equal to the half aperture angle of the transducer

Focusing of ultrasonic waves can be achieved using either a lens or by opting for a lens-less approach. In the latter case, a flexible piezo polymer element, such as a Polyvinylidene Fluoride (PVDF) layer, serves as the active element in the transducer. This flexible element is shaped into either a hemisphere or a half-cylinder, effectively focusing the sound waves as needed. The presence of edge waves, arising due to diffraction effects at the transducer's edge, is a recognized phenomenon. In conventional acoustic microscopy, the presence of these edge waves is generally considered a disadvantage. This is particularly relevant in high-frequency imaging applications where image resolution is critical. The presence of edge waves can significantly degrade image quality.

Furthermore, the half-aperture angle of the focused transducer is a crucial geometric characteristic that has a direct impact on the generation of acoustic wave signals within the material. For efficiently generation of acoustic wave signals in any material, matching the transducer's aperture angle with the critical angles of the material is necessary. This can be achieved by employing a larger element diameter and shorter wavelength. However, it's important to note that attaining a large element diameter for very high-frequency lens-less transducers poses a considerable challenge.

Thus, there is a scope for improvement and need to provide system and method for improving the imaging and characterization of materials, particularly in scenarios where conventional ultrasound methods face limitations.

### SUMMARY OF THE DISCLOSURE

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In an aspect, the present disclosure recites an acoustic microscopy arrangement for determining material property of a sample using edge wavefront signal. The arrangement comprises a curved ultrasonic transducer mounted over top surface of the sample such that the transducer is adjustable in 3 dimensions. The curved ultrasonic transducer is designed without apodization at boundaries. The system further comprises a pulse generator/receiver operatively coupled to the curved ultrasonic transducer, the pulse generator/receiver is configured to provide electrical signal for excitation of the curved ultrasonic transducer and a control unit in communication with the curved ultrasonic transducer. The control unit is configured to generate, using the excited curved ultrasonic transducer, an acoustic wavefront signal that includes an edge wavefront signal and guide the generated acoustic wavefront signal towards the top surface of the sample for a pre-determined period of time. The control unit is further configured to iteratively adjust a defocus distance between the curved ultrasonic transducer and the top layer of the sample. After guiding the signals, the control unit is configured to receive a plurality of reflected acoustic wave signals from the sample for each of the adjusted defocus distance and generate information for each of the defocus distance based on the plurality of received reflect acoustic wave signals. The generated information represents amplitude of the plurality of reflected acoustic wave signals and penetration depth of the acoustic wavefront signal within the sample. Sequentially, the control unit is configured to analyze the information for each of the defocus distance to determine the material property of the sample.

In an another aspect, the present disclosure recites that the control unit in order to analyze the information is configured to generate a plurality of curves based on the information. Each of the plurality of curves is related to velocity of the reflected acoustic wave signals and the defocus distances. After generation of curves, the control unit is configured to analyze the generated curve to identify modes related to the acoustic wavefront signal and generate the material property based on the analyzed curved.

In an another aspect, the present disclosure recites that the control unit in order to analyze the information is configured to identify the modes related to acoustic wavefront signal. After identification of the modes, the control unit is configured to compare wave property of modes in the curve with a predefined wave property of modes present in a database of the arrangement and determine material property of the sample based on the comparison.

In another aspect, the present disclosure recites the control unit is configured to control incident angle of the acoustic wavefront signal. The control unit is further configured to control incident angle of the acoustic wavefront signal of the curved ultrasonic transducer based on the element diameter and focal length of the transducer.

In another aspect, the present disclosure recites that the control unit comprises a remote pulse unit operatively coupled to the pulse generator. The remote pulse unit is configured to amplify the electrical signal sent to the curved ultrasonic transducer for excitation.

In another aspect, the present disclosure, recites the control unit is configured to generate surface velocity of the sample based the generated plurality of curves.

In an aspect, the present disclosure may recite an acoustic microscopy method for determining material property of a sample using acoustic wavefront signal. The method includes mounting a curved ultrasonic transducer over a top surface of the sample such that the curved ultrasonic transducer is adjustable in 3 dimensions. The curved ultrasonic transducer is designed without apodization at boundaries. The method further includes providing electrical signal for excitation of the curved ultrasonic transducer and generating, using the excited curved ultrasonic transducer, an acoustic wavefront signal that includes an edge wavefront signal. Sequentially, the method further includes guiding the generated acoustic wavefront signal towards the top surface of the sample for a pre-determined period of time and iteratively adjusting a defocus distance between the curved ultrasonic transducer and the top layer of the sample. After guiding the generated acoustic wavefront signal, the method further includes receiving a plurality of reflected acoustic wave signals from the sample for each of the adjusted defocus distance and generating information for each of the defocus distance based on the plurality of received reflect acoustic wave signals. The generated information represents amplitude of the plurality of reflected acoustic wave signals and penetration depth of the acoustic wavefront signal within the sample. Finally, the method includes analyzing the information for each of the defocus distance to generate the material property of the sample.

In another aspect, the present disclosure recites a method, to analyze the generated information, that include generating a plurality of curves based on the information. Each of the plurality of curves is related to velocity of the reflected acoustic wave signals and the defocus distances. The method further includes analyzing the generated curve to identify modes related to the acoustic wavefront signal and generating the material property of the sample based on the analyzed curved.

In another aspect, the present disclosure recites a method, to further determine material property of the sample based on the identified modes, that include identifying the modes related to acoustic wavefront signal. The method further includes comparing wave property of modes in the curve with a predefined wave property of modes present in a database and determining material property of the sample based on the comparison.

In another aspect, the present disclosure recites a method that includes controlling incident angle of the acoustic wavefront of the curved ultrasonic transducer based on the element diameter and focal length of the transducer.

In another aspect, the present disclosure recites a method that includes amplifying the electrical signal sent to the curved ultrasonic transducer for excitation.

In another aspect, the present disclosure recites a method that includes generating surface velocity of the sample based the generated plurality of curves.

In an aspect, present disclosure recites non-transitory computer-readable medium that stores instructions, that when executed by one or more processors of an acoustic microscopy arrangement, causes the acoustic microscopy arrangement to perform various operations, including mounting a curved ultrasonic transducer over a top surface of the sample such that the curved ultrasonic transducer is adjustable in 3 dimensions. The curved ultrasonic transducer is designed without apodization at boundaries. The stored non-transitory computer-readable medium instruction may be configured to cause the acoustic microscopy arrangement to perform operation further including providing electrical signal for excitation of the curved ultrasonic transducer and generating, using the excited curved ultrasonic transducer, an acoustic wavefront signal that includes an edge wavefront signal and guiding the generated acoustic wavefront signal towards the top surface of the sample for a pre-determined period of time and iteratively adjusting a defocus distance between the curved ultrasonic transducer and the top layer of the sample. After guiding the generated acoustic wavefront signal, the stored non-transitory computer-readable medium instruction may be configured to cause the acoustic microscopy arrangement to perform operation receiving a plurality of reflected acoustic wave signals from the sample for each of the adjusted defocus distance and generating information for each of the defocus distance based on the plurality of received reflect acoustic wave signals. The generated information represents amplitude of the plurality of reflected acoustic wave signals and penetration depth of the acoustic wavefront signal within the sample. Finally, the stored non-transitory computer-readable medium instruction may be configured to cause the acoustic microscopy arrangement to perform operation including analyzing the information for each of the defocus distance to generate the material property of the sample.

In another aspect, to analyze the generated information, the stored non-transitory computer-readable medium instruction may be configured to cause the acoustic microscopy arrangement to perform operation further including generating a plurality of curves based on the information. Each of the plurality of curves is related to velocity of the reflected acoustic wave signals and the defocus distances. After generating the information, the stored non-transitory computer-readable medium instruction may be configured to cause the acoustic microscopy arrangement to perform operation further including analyzing the generated curve to identify modes related to the acoustic wavefront signal and generating the material property of the sample based on the analyzed curved.

In an another aspect, to determine material property of the sample based on the identified modes, the stored non-transitory computer-readable medium instruction may be configured to cause the acoustic microscopy arrangement to perform operation further including identifying the modes related to acoustic wavefront signal, comparing wave property of modes in the curve with a predefined wave property of modes present in a database, and determining material property of the sample based on the comparison.

In an another aspect, the stored non-transitory computer-readable medium instruction may be configured to cause the acoustic microscopy arrangement to perform operation further including controlling incident angle of the acoustic wavefront of the curved ultrasonic transducer based on the element diameter and focal length of the transducer.

In another aspect, the stored non-transitory computer-readable medium instruction may be configured to cause the acoustic microscopy arrangement to perform operation further including amplifying the electrical signal sent to the curved ultrasonic transducer for excitation.

In another aspect, the stored non-transitory computer-readable medium instruction may be configured to cause the acoustic microscopy arrangement to perform operation further including generating surface velocity of the sample based the generated plurality of curves.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an environment architecture for acoustic microscopy arrangement for determining material property of a sample using edge wavefront signal, in accordance with an embodiment of the present disclosure.

FIG. 2 illustrates a schematic diagram of the curved ultrasonic transducer, in accordance with an embodiment of the present disclosure.

FIG. 3 illustrates exemplary embodiment of incident angles for the edge wavefront of the curved ultrasonic transducer and the wavefront of conventional ultrasonic transducer, in accordance with an embodiment of the present disclosure.

FIG. 4 illustrates by way of a block diagram of an acoustic microscopy arrangement for determining material property of a sample using edge wavefront signal, in accordance with an embodiment of the present disclosure.

FIG. 5 illustrates by way of a block diagram of an acoustic microscopy arrangement for analyzing may analyze the datasets to generate the material property of the sample, in accordance with an embodiment of the present disclosure.

FIGS. 6a-6b illustrates exemplary embodiment of identification of modes based on the curves, in accordance with an embodiment of the present disclosure.

FIGS. 7a-7d illustrates exemplary embodiment of identification of modes based on the curves, in accordance with an alternative embodiment of the present disclosure.

FIG. 8 a flow diagram illustrating acoustic microscopy method 800 for determining material property of a sample using edge wavefront signal, in accordance with an embodiment of the present disclosure.

FIG. 9 illustrates by way of a block diagram of an acoustic microscopy arrangement for determining material property of a sample using edge wavefront signal, in accordance with an embodiment of the present disclosure

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

Various embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Disclosed herein is an acoustic microscopy arrangement for determining material property of a sample using edge wavefront signal. The arrangement may comprise a curved ultrasonic transducer mounted over top surface of the sample such that the transducer is adjustable in 3 dimensions. The curved ultrasonic transducer is designed without apodization at boundaries. The system may comprise a pulse generator/receiver operatively coupled to the curved ultrasonic transducer, the pulse generator/receiver may be configured to provide electrical signal for excitation of the curved ultrasonic transducer and a control unit in communication with the curved ultrasonic transducer. The control unit may be configured to generate, using the excited curved ultrasonic transducer, an acoustic wavefront signal that includes an edge wavefront signal and guide the generated acoustic wavefront signal towards the top surface of the sample for a pre-determined period of time and iteratively adjust a defocus distance between the curved ultrasonic transducer and the top layer of the sample. After guiding the signals, the control unit may be configured to receive a plurality of reflected acoustic wave signals from the sample for each of the adjusted defocus distance and generate information for each of the defocus distance based on the plurality of received reflect acoustic wave signals. The generated information represents amplitude of the plurality of reflected acoustic wave signals and penetration depth of the acoustic wavefront signal within the sample. Sequentially, the control unit may be configured to analyze the information for each of the defocus distance to determine the material property of the sample. An embodiment of the present disclosure may provide a method and a system for utilizing of edge wavefront signal in order to efficiently generate and utilize acoustic edge waves, even when the transducer aperture angle is not ideally matched with the critical angles of the material. The utilizing of edge wavefront signal improved imaging and materials analysis in scenarios where traditional methods might be limited by the geometric constraints of the transducer's aperture angle.

Turning now to the drawings, the detailed description set forth below in connection with the appended drawings is intended as a description of various configurations and is not intended to represent the only configurations in which the concepts described herein may be practiced. The detailed description includes specific details for the purpose of providing a thorough understanding of various concepts with like numerals denote like components throughout the several views. However, it will be apparent to those skilled in the art that these concepts may be practiced without these specific details.

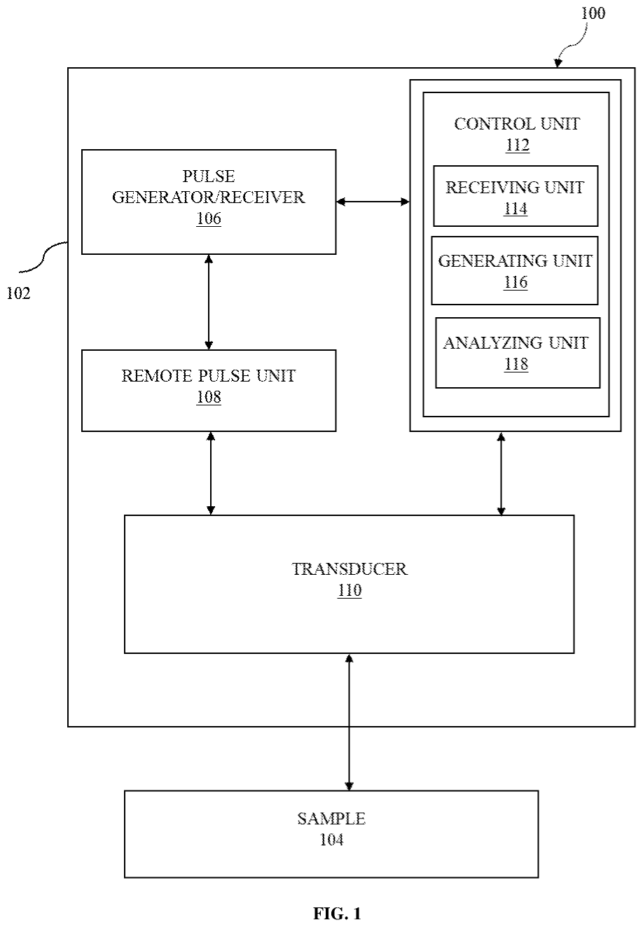

FIG. 1 illustrates a semantic representation of Scanning Acoustic Microscope (SAM) 100, in accordance with an embodiment of the present disclosure. The SAM 100 may be constituted by an arrangement 102 and a sample 104. Further, the arrangement 102 may be constituted by a pulse generator/receiver 106, a remote pulse unit 108, a transducer 110, and a control unit 112. All the constituent elements of the arrangement 102 illustrated in FIG. 1 are essential constituent elements, however the arrangement 102 may be implemented by more constituent elements than the constituent elements illustrated in FIG. 1 and the same are not explained for the sake of brevity. The control unit 112 may communicate with all of the constituent elements of the arrangement 102. Components present in the control unit 112 may communicate with the pulse generator/receiver 106, the remote pulse unit 108, and the transducer 110 via wired communication network.

In an embodiment, the pulse generator/receiver 106 may serve a purpose of both generating initial ultrasonic pulse signal and receiving the signals reflected or transmitted by the sample 104. The pulse generator/receiver 106 may be an electronic circuit used to generate an impulse excitation pulse. The impulse excitation pulse is a short burst of electrical energy that is applied to the transducer 110. This electrical energy may be converted into mechanical energy by the transducer 110, resulting in the generation of a high-frequency ultrasonic pulse signals.

In an embodiment, the remote pulse unit 108 may serve a purpose of amplifying impulse excitation pulse and the weak ultrasonic signals that may be received after ultrasonic pulse signals may interact with the sample 104. In particular, when the remote pulse unit 108 may receive impulse excitation pulse from the pulse generator/receiver 106, the remote pulse unit 108 may amplify the impulse excitation pulse and provide the amplified impulse excitation pulse to the transducer 110.

Additionally, when the ultrasonic wave signals may propagate through the sample 104, some of them may get reflected or transmitted, carrying information about the sample properties. However, these signals may be relatively weak, making it essential to amplify them for accurate detection and analysis. The remote pulse unit 108 may receive the reflected ultrasonic wave signals and amplifies the amplitude (strength) of the reflected ultrasonic wave signals in order to effectively processed and analyzed the reflected ultrasonic wave signals. After amplifying the received reflected ultrasonic wave signals, the remote pulse unit 108 may transmit the amplified signals to the pulse generator/receiver 106. The pulse generator/receiver 106 may provide the reflected amplified signals to the control unit 112.

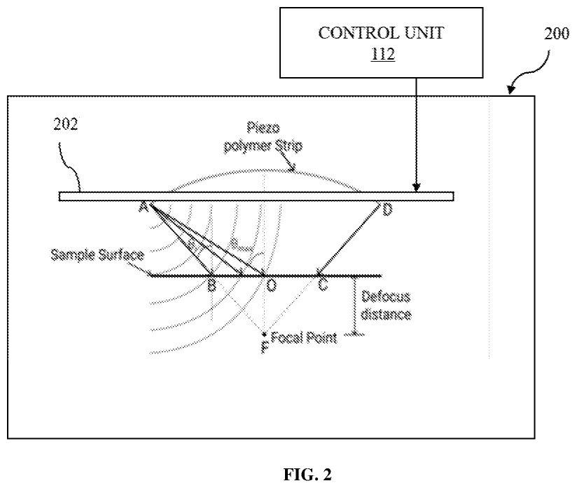

In an embodiment, the transducer 110 may serve a dual function in the SAM 100. The transducer 110 may act both as a transmitter and a receiver of ultrasonic wave signals. In particular, the transducer 110 may convert electrical signals into mechanical vibrations, generating an ultrasonic pulse that propagates through the medium (usually water) and interacts with the sample 104. Additionally, the transducer 110 may detect the ultrasonic wave signals reflected from or transmitted through the sample and convert them back into electrical signals. The detailed structure of the transducer 110 may be further explained in FIG. 2 in forthcoming paragraphs of the present disclosure.

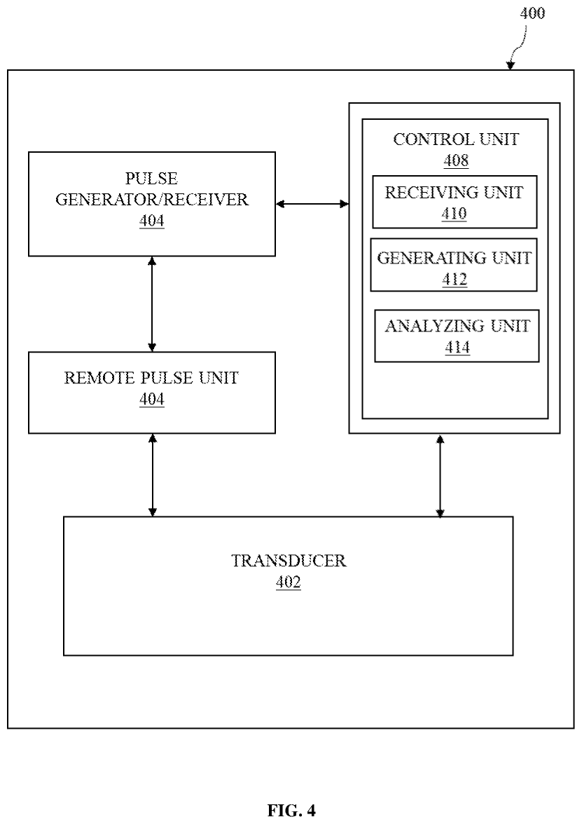

In an embodiment, the control unit 112 may comprise a receiving unit 114, a generating unit 116, and a analyzing unit 118. The constituted elements of the control unit 112 may communicate with all other constituent elements of the arrangement 102 in order to determining material property of the sample 104 using edge wavefront signal. The detailed functioning of the control unit 112, in conjunction with other elements disclosed in FIG. 1, may be further explained in FIG. 4 in forthcoming paragraphs of the present disclosure.

In an embodiment, the sample 104 may refer to material or object under investigation using acoustic microscopy. The sample may be, not limited to, solid materials, biological samples, electronic components, microelectronics, and so forth.

Moving towards FIG. 2 that illustrates a schematic diagram of the curved ultrasonic transducer 200 (same the transducer 110 of FIG. 1), in accordance with an embodiment of the present disclosure.

In a conventional acoustic microscopy, a flat or planar transducer may be used. The conventional transducer may emit ultrasound waves in a straight, planar fashion, which may limit ability of the conventional transducer to focus effectively at varying depths within a sample (such as the sample 104 of FIG. 1). The present disclosure may use the curved ultrasonic transducer 200 for the emission of ultrasound waves which may enable the arrangement (such as arrangement 102 of FIG. 1) to achieve multi-point focusing at different depths within the sample 104 simultaneously. In an embodiment, the curved ultrasonic transducer 200 may be mounted on over top of the sample 104.

In a conventional acoustic microscopy, the transducer are designed with apodization. The apodization may be a technique widely employed in ultrasound imaging to shape and control the intensity of the transmitted ultrasound beam. The primary purpose of the apodization may be to reduce the formation of unwanted side lobes and improve image quality by modifying the amplitude of ultrasound waves across the transducer's active element. By tapering the amplitude at the edges of the element, apodization may mitigate side lobes, which are lower-intensity waves that can generate artifacts and degrade image quality. In the present disclosure, the curved ultrasonic transducer 200 may be designed without apodization at boundaries means that the transducer effectively manages the ultrasound beam properties near the edges.

In an embodiment, the curved ultrasonic transducer 200 may include a transducer holder 202 that enables manual coarse adjustments in three key directions, namely x, y, and z of the transducer 200. The transducer holder 202 may be in communication with a control unit (such as the control unit 112 of FIG. 1) via wirelessly or wired. Based on the signal from the control unit 112, the transducer holder 202 may adjust the transducer in 3 dimensions. In an embodiment, the transducer holder 202, based on the signal received from the control unit 112, may move in the x and y directions based on the received signal. In an another embodiment, the transducer holder 202, based on the signal from the control unit 112, may move in the z direction (i.e. vertical movement towards or away from the sample).

In an embodiment, the ultrasonic wave generated by a curved ultrasonic transducer 200 may be edge wavefront signal.

In the conventional acoustic microscopy which utilize the apodization at boundaries, the maximum angle of incidence for the transducer main wavefront is limited to the half aperture angle. This means that the ultrasonic waves generated by the transducer may be incident on a sample at angles up to the half aperture angle from the normal (perpendicular) to the sample's surface. This angle limitation is due to the design and properties of the conventional transducer used in the conventional acoustic microscopy. In view of the ordinary skilled in the art, the aperture angle depends on the element diameter and radius curvature of the transducer.

In the present disclosure, i.e., in edge wave acoustic microscopy transducer (curved ultrasonic transducer 200), the maximum angle of incidence for ultrasonic waves may be extended to more than twice the half aperture angle by utilizing the edge wave. This is a significant improvement compared to the conventional acoustic microscopy, and it allows for a wider range of incident angles when imaging or inspecting materials.

The wide range of incident angles (i.e., ⊖ₘᵢₙ) for the edge wavefront signal of the curved ultrasonic transducer may be achieved by controlling two key parameters such as the element diameter of the curved ultrasonic transducer 200 and the focal length of the curved ultrasonic transducer 200. In particular, the control of the element diameter of curved ultrasonic transducer 200 may be typically achieved during the manufacturing or design process of the curved ultrasonic transducer. Additionally, the control of the focal length of the curved ultrasonic transducer 200 may performed by adjusting the defocus distance between the curved ultrasonic transducer 200 and the sample 104. The defocus distance may be adjusted by controlling the transducer holder 202. As described in the forthgoing paragraphs, transducer holder 202 may be controlled based on the signal received from the control unit 112.

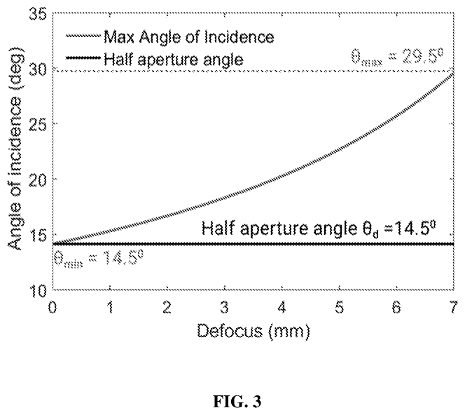

In order to understand the range of the incident angles reference may be made to FIG. 3. Moving on to FIG. 3, exemplary embodiment of incident angles for the edge wavefront signal of the curved ultrasonic transducer 200 and the wavefront of conventional ultrasonic transducer. The incident angle of the conventional ultrasonic transducer may not change in view of change of defocus distance between the conventional transducer and the sample. The incident angle for conventional ultrasonic transducer may be represented as a black line and limited to only 14.5°. The present disclosure overcome this limitation, by changing the incident angle for the edge wavefront signal of the curved ultrasonic transducer 200 in view of change of the defocus distance. In an embodiment, the minimum incident angle (⊖ₘᵢₙ) for the edge wavefront signal of the curved ultrasonic transducer may be 14.5° and maximum incident angle (⊖ₘₐₓ) for the edge wavefront signal of the curved ultrasonic transducer may be 29.5°. The incident angle for curved ultrasonic transducer 200 may be represented as a red line in the FIG. 3. In an embodiment, the incident angle of the conventional transducer and curved ultrasonic transducer is not limited to above mentioned range and depends on the property of the transducer.

In order to understand the functioning of the curved ultrasonic transducer 200 in view of the arrangement 102 of FIG. 1, FIG. 4 may also be considered. Moving towards FIG. 4 that illustrates an acoustic microscopy arrangement 400 (same as the arrangement 102 of FIG. 1) for determining material property of a sample (such as the sample 104 of FIG. 1) using edge wavefront signal, in accordance with an embodiment of the present disclosure. The acoustic microscopy arrangement 400 may be constituted by a pulse generator/receiver 404 (same as the pulse generator/receiver 106 of FIG. 1), a remote pulse unit 406 (same as the remote pulse unit 108 of FIG. 1), a curved ultrasonic transducer 402 (same as the transducer 110 of FIG. 1), and a control unit 408 (same as the control unit 112 of FIG. 1). The general description and functioning of all the constituted elements already described in forthgoing paragraphs of FIG. 1.

In an embodiment, the control unit 408 may comprise a receiving unit 410 (same as the receiving unit 114 of FIG. 1), a generating unit 412 (same as the generating unit 116 of FIG. 1), and a analyzing unit 414 (same as the analyzing unit 118 of FIG. 1).

In a non-limiting embodiment of the present disclosure, the control unit 408 may be configured to generate, using the excited curved ultrasonic transducer 402, an acoustic wavefront signal that may include an edge wavefront signal. Sequentially, the control unit 408 may guide the generated acoustic wavefront signal towards the top surface of the sample for a pre-determined period of time and iteratively adjusting a defocus distance between the curved ultrasonic transducer and the top layer of the sample.

In particular, the generating unit 412 may generate and provide a control signal to the pulse generator/receiver 404 to excite the curved ultrasonic transducer 402. The excited curved ultrasonic transducer 402 may generate acoustic edge wavefront signal. The generating unit 412 may guide the generated acoustic wavefront signal towards the top surface of the sample (same as the sample 104 of FIG. 1). Further, the generating unit 412 may iteratively adjust the defocus distance between the curved ultrasonic transducer and the top layer of the sample 104. This adjustment may be performed repeatedly, possibly with incremental changes, over a pre-determined period of time. For example, the control unit 408 may guide the generated acoustic edge wavefront signal towards the sample 104 for a period of time “t1”. After the completion of the period “t1”, the control unit 408 may adjust the defocus distance and guide the generated acoustic edge wavefront signal towards the sample 104.

In an embodiment, the acoustic edge wavefront signal may be collection of the rays travelling at different angles towards the surface of the sample 104. In particular, after the generation of the acoustic edge wavefront signal, a portion of the acoustic edge wavefront signal may include a normal incidence with the surface of the sample 104. The normal incidence of the acoustic edge wavefront signal may be responsible for generation of specular reflection. Remaining portion of the acoustic edge wavefront signal may include an angular incidence with the surface of the sample 104. The angular incidence of the acoustic edge wavefront signal may be responsible for generation of surface wave in the sample 104.

After guiding the acoustic edge wavefront signal towards the sample 104, in a non-limiting embodiment of the present disclosure, the control unit 408 may be configured to receive a plurality of reflected acoustic wave signals from the sample 104 for each of the adjusted defocus distance and generate information for each of the defocus distance based on the plurality of received reflect acoustic wave signals. The generated information may represent amplitude of the plurality of reflected acoustic wave signals and penetration depth of the acoustic wavefront signal within the sample 104.

In particular, after guiding the acoustic edge wavefront signal towards the sample 104, the remote pulse unit 406 may receive the reflected acoustic wave signals from the sample 104 and amplify the received reflected acoustic wave signals. After that, the pulse generator/receiver 404 may receive the amplified reflected acoustic wave signals and provide the amplified reflected acoustic wave signals to the receiving unit 410. The receiving unit 410 may provide the amplified reflected acoustic wave signals to the generating unit 412. The generating unit 412, for each of the defocus distances, may extract the amplitude of the plurality of reflected acoustic wave signals. In an embodiment, amplitude may represent the strength or intensity of the reflected acoustic wave signals. In addition to extraction of the amplitude, the generating unit 412 may extract information related to penetration depth of the reflected acoustic wave signals within the sample 104. In an embodiment, penetration depth may indicate how far into the sample 104 the acoustic wave has traveled before being reflected. After extracting the amplitude and information related to penetration depth, the generating unit 412 may generate datasets specific to each defocus distance. These datasets may contain information about the amplitude and penetration depth of reflected acoustic wave signals for that particular defocus distance.

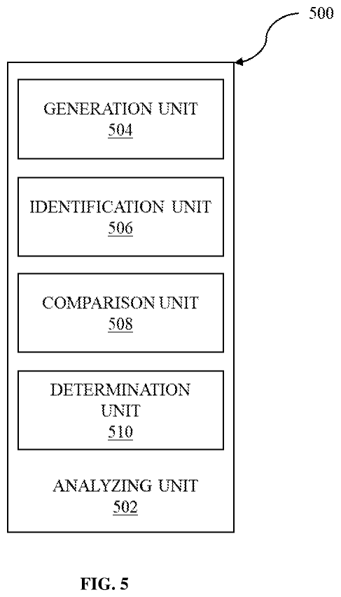

After generation of the datasets, the generating unit 412 may provide the datasets to the analyzing unit 414. The analyzing unit 414 may analyze the datasets to generate the material property of the sample. The analysis of the datasets to generate the material property of the sample is further explained in forthcoming paragraphs of FIG. 5.

Moving on to FIG. 5 that illustrates an acoustic microscopy arrangement 500 (same as the arrangement 400 of FIG. 2) for analyzing the datasets to generate the material property of the sample, in accordance with an embodiment of the present disclosure. For this, the arrangement 500 indicates that the analyzing unit 502 (same as the analyzing unit 414 of FIG. 4) may be configured to analyze the datasets to generate the material property of the sample. The constituent elements of the analyzing unit 502 may include one or more sub-units including but not limited to a generation unit 504, identification unit 506, and a comparison unit 508, and a determination unit 510. All the constituent elements of the analyzing unit 502 illustrated in FIG. 5 are not essential constituent elements, and the analyzing unit 502 may be implemented by more constituent elements than the constituent elements illustrated in FIG. 5, however the same are not explained for the sake of brevity. All the constituent elements of the analyzing unit 502 may communicate with each other via wireless/wired communication network.

In a non-limiting embodiment of the present disclosure, the analyzing unit 502 may be configured to generate a plurality of curves based on the information, wherein each of the plurality of curves is related to velocity of the reflected acoustic wave signals and the defocus distances. After that, the analyzing unit 502 may analyze the generated curve to identify modes related to the acoustic wavefront signal and compare wave property of modes in the curve with a predefined wave property of modes present in a database of the arrangement to determine material property of the sample based on the comparison.

In particular, the generation unit 504 may receive the generate information for each of the defocus distance from the generation unit 414. The generation unit 504 may use one or more predefined techniques to generate the curves for each defocus distance based on the generated information. In an embodiment, each curve may be associated with a specific defocus distance used during the acoustic microscopy process. In an another embodiment, each curve may be a plot between the velocity and frequency. After that, the generation unit 504 may provide the information related to the curves to the identification unit 506. The identification unit 506 may use one or more predefined techniques to identify modes based on the information related to the curves. The identified modes may be associated with the acoustic edge wavefront signal.

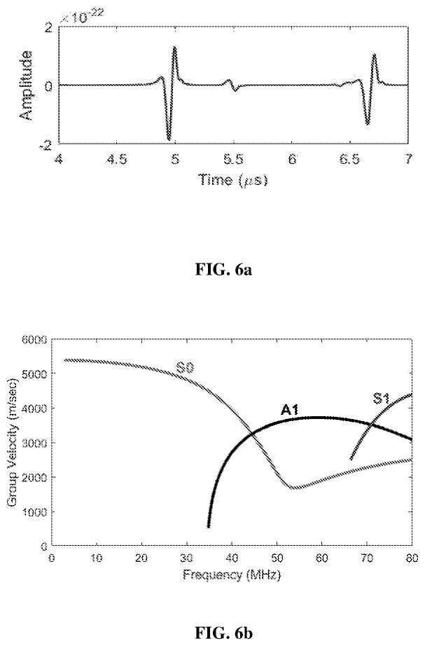

In order to understand the identification of modes based on the curves, FIG. 6 must be considered. FIG. 6 illustrate exemplary embodiment of the present disclosure. The sample 104 may be an Aluminum plate and defocus distance between the sample 104 and the transducer 402 may be 7 mm. The generation unit 504 may receive the information of reflected wave signals for a predefined time period (i.e., 4-7 μs). FIG. 6(a) may represent a plot of amplitude of the reflected acoustic signal as a function of time (or depth) for the Aluminum plate. The curve illustrated in FIG. 6(a) may be obtained based on the received information associated with the 7 mm defocus distance between the sample 104 and the transducer 402.

FIG. 6(b) may represent a plot between the velocity of the reflected wave signals and the frequency associated with the reflected wave signals for the Aluminum plate. In order to generate the plot, the generation unit 504 may receive the information of the reflected signals in view of the Aluminum plate sample for the 7 mm defocus distance. After receiving the information, the generation unit 504 may generate the velocity curve based on the received information and the curve that represent a plot of amplitude of the reflected acoustic signal as a function of time. The generation unit 504 may provide the velocity curve to the identification unit 506. The identification unit 506 may identify the modes based on the velocity curve. The identified modes for this case may be a symmetric fundamental mode (S0), a first order mode of anti-symmetric, and a first order mode of symmetric (S1) as represented in FIG. 6(b).

After identifying the modes, the identification unit 506 may provide the information related to identified modes along with the information related to the received reflected acoustic wave signals to the comparison unit 508. In an embodiment, the comparison unit 508 may compare the properties of the identified modes within the generated curve with the properties stored in the predefined database. In an embodiment, the comparison unit 508 may include a collection of predefined wave properties. These predefined properties may serve as a reference library of known wave behaviors. These properties may include details about the expected shape, frequency, amplitude, and other features of waves under various conditions.

The comparison unit 508 may provide a comparison result to the determination unit 510. The determination unit 510 may determine material property of the sample 104 based on the comparison result received from the comparison unit 508.

In an alternative embodiment of the present disclosure, the analyzing unit 502 may be configured to generate a plurality of curves based on the information, wherein each of the plurality of curves is related to A-scan curve and B-scan curve. After that, the analyzing unit 502 may analyze the generated curve to identify modes related to the acoustic wavefront signal and compare wave property of modes in the curve with a predefined wave property of modes present in a database of the arrangement to determine material property of the sample based on the comparison.

In particular, the generation unit 504 may generates multiple curves. Each curve may be associated with a specific defocus distance used during the acoustic microscopy process. The generation unit 504 may receive the generate information for each of the defocus distance from the generation unit 414 of FIG. 4. The generation unit 504 may use one or more predefined techniques to generate the a first plurality of curves and second plurality of curves for each defocus distance based on the generated information and a for each defocus distance. Each of the first plurality of curves (i.e. A-scan) may be a plot of amplitude of the reflected acoustic signal as a function of time (or depth). Each of second plurality of curves (i.e. B-scan) may be a compilation and collection of data collected from each A-scan. After that, the generation unit 504 may provide the information related to the first curves and second curves to the identification unit 506. The identification unit 506 may include a predefined algorithm to identify modes based on the information related to the curve. The identified modes may be associated with the acoustic edge wavefront signal.

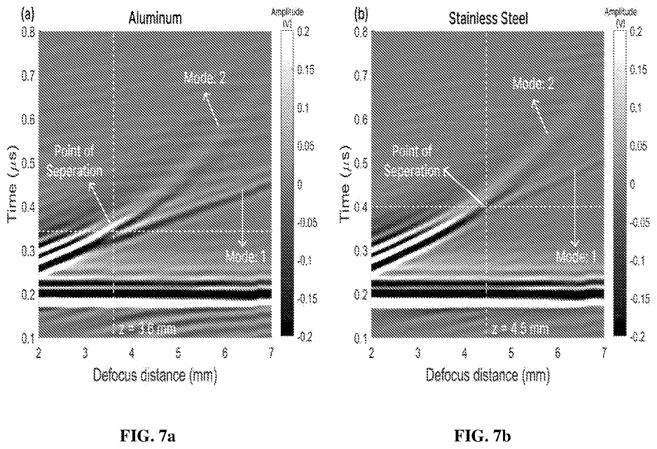

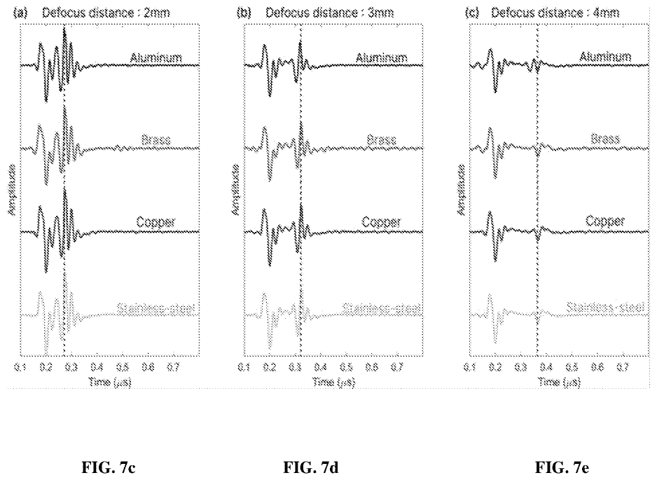

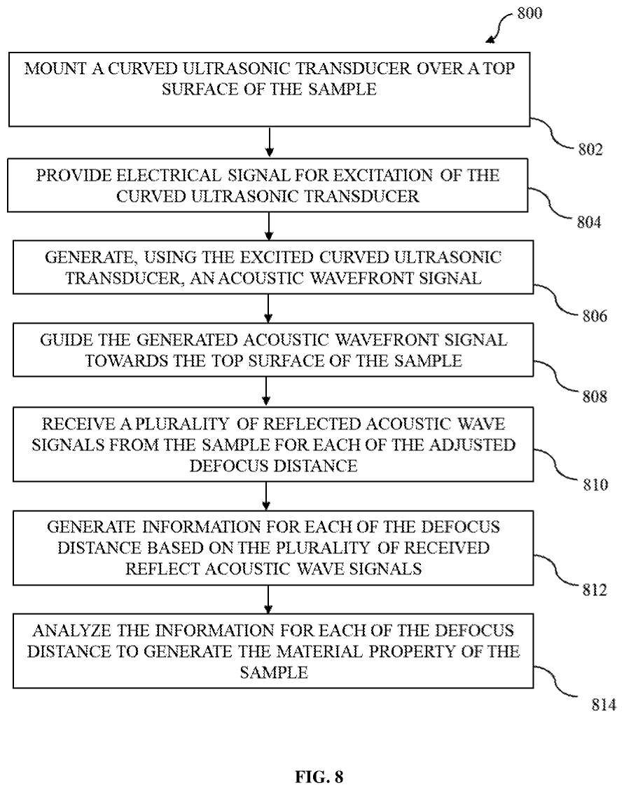

In order to understand the identification of modes based on the curves in view of the alternative embodiment reference may be made to FIGS. 7a-7d. Moving towards FIGS. 7a-7d which illustrate exemplary embodiment of the present disclosure. FIG. 7(a) may represent the B-scan of aluminum and FIG. 7(b) may represent the B-scan of stainless steel obtained from the defocusing measurement (i.e., dataset collected from the reflect acoustic wave signals). In the aluminum sample, the separation point may be 3.6 mm defocus, while in stainless steel, the same may be 4.5 mm. FIGS. 7(a) and 7(b) may indicate that the slope of mode-1 in aluminum is less than that of Stainless steel. This behavior may indicate that mode-1 travels faster in aluminum than in stainless steel. FIGS. 7(a) and 7(b) may indicate The travel path of mode-2 may look to be similar in both samples.

Now moving towards FIGS. 7(c)-7(e) shows the time of flight (TOF) comparison of A-scans obtained from different material samples at a 2 mm defocus distance. FIGS. 7(c)-7(e) may represent a similar comparison for a 3 and 4 mm defocus position, respectively. From the comparison, the TOF of mode-2 may be the same for all the samples for a particular defocus distance. This observation may indicate that mode-2 is a direct reflection from the sample surface, which does not have any travel path through the material sample. From the analysis of FIGS. 7a-7e, mode-1 is a surface wave with some of its travel paths through the sample surface and mode-2 is a direct reflection from the sample surface.

After identifying the modes, the identification unit 504 may provide the information related to identified modes along with the information related to the received reflected acoustic wave signals to the comparison unit 508. In an embodiment, the comparison unit 508 may compare the wave properties of the identified modes within the generated curve with the wave properties stored in the predefined database. In an embodiment, the comparison unit 508 may include a collection of predefined wave properties. These predefined properties may serve as a reference library of known wave behaviors. These properties may include details about the expected shape, frequency, amplitude, and other features of waves under various conditions.

The comparison unit 508 may provide a result to the determination unit 510. The determination unit 510 may determine material property of the sample 104 based on the result from the comparison unit 508.

In addition to determination of material property, the generation unit 504 may generate surface velocity in the sample. In particular, the surface velocity in a particular sample may be calculated by using equation (1) and B-scan of the particular sample.

$${V}_{SW} = \frac{2 * {A}_{S}}{\sqrt{\frac{4 * {A}_{S}}{{V}_{W}} - 1}} \qquad ( 1 )$$

V_{SW}: Velocity of the surface wave.
A_{S}: Slope of the time-of-flight vs defocus plot.
V_{W}: Velocity of couplant (i.e. water).

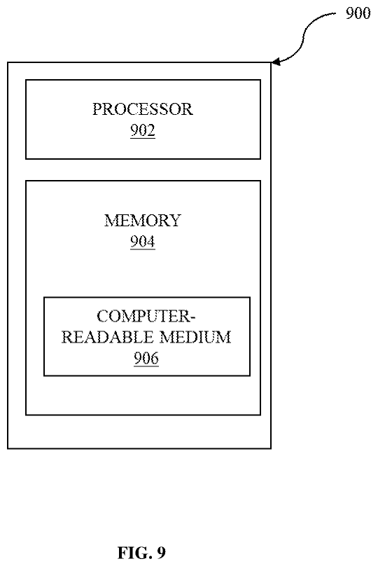

Moving towards FIG. 8 showing steps of an acoustic microscopy method 800 for determining material property of a sample using edge wavefront signal. The method starts at step 802, at a step 802 the method 800 may include mounting a curved ultrasonic transducer over a top surface of the sample such that the curved ultrasonic transducer is adjustable in 3 dimensions. The curved ultrasonic transducer is designed without apodization at boundaries. In an exemplary aspect, the arrangement 400 of FIG. 4 may be configured to carry out the process steps disclosed in step 802.

At a step 804, the method 800 may providing electrical signal for excitation of the curved ultrasonic transducer. Further, the method 800 may include amplifying the electrical signal sent to the curved ultrasonic transducer for excitation. In an exemplary aspect, a pulse generator/receiver 404 and a remote pulse unit 406 of FIG. 4 of the arrangement 400 may be configured to carry out the process steps disclosed in step 804.

At a step 806, the method 800 may include generating, using the excited curved ultrasonic transducer, an acoustic wavefront signal that includes an edge wavefront signal. In an exemplary aspect, a control unit 408 along with the transducer 402 of FIG. 4 of the arrangement 400 may be configured to carry out the process steps disclosed in step 806.

At a step 808, the method 800 may include guiding the generated acoustic wavefront signal towards the top surface of the sample for a pre-determined period of time and iteratively adjusting a defocus distance between the curved ultrasonic transducer and the top layer of the sample. In an exemplary aspect, the control unit 408 may be configured to carry out the process steps disclosed in step 808.

At a step 810, the method 800 may include receiving a plurality of reflected acoustic wave signals from the sample for each of the adjusted defocus distance. In an exemplary aspect, the control unit 408 may be configured to carry out the process steps disclosed in step 810.

At a step 812, the method 800 may include generating information for each of the defocus distance based on the plurality of received reflect acoustic wave signals. The information represents amplitude of the plurality of reflected acoustic wave signals and penetration depth of the wavefront signal within the sample. In an exemplary aspect, the control unit 408 may be configured to carry out the process steps disclosed in step 812.

At a step 814, the method 800 may include generating information for each of the defocus distance based on the plurality of received reflect acoustic wave signals. The information represents amplitude of the plurality of reflected acoustic wave signals and penetration depth of the wavefront signal within the sample. In an exemplary aspect, the control unit 408 may be configured to carry out the process steps disclosed in step 814.

At a step 816, the method 800 may include analyzing the information for each of the defocus distance to generate the material property of the sample. The analyzing may further include generating a plurality of curves based on the information, wherein each of the plurality of curves is related to velocity of the reflected acoustic wave signals and the defocus distances and analyzing the generated curve to identify modes related to the acoustic wavefront signal.

After identifying the modes, comparing wave property of modes in the curve with a predefined wave property of modes present in a database and determining material property of the sample based on the comparison. Additionally, the method 800 may include generating surface velocity of the sample based the generated plurality of curves. In an exemplary aspect, the control unit 408 may be configured to carry out the process steps disclosed in step 816.

The technical effect associated with the present disclosure as shown below:

An embodiment of the present disclosure may provide a method and a system for edge wavefront signal in order to efficiently generate and utilize acoustic edge waves even when the transducer aperture angle is not ideally matched with the critical angles of the material. utilizing of edge wavefront signal improved imaging and materials analysis in scenarios where traditional methods might be limited by the geometric constraints of the transducer's aperture angle.

An embodiment of the present disclosure may provide a method and a system for improving the imaging and characterization of materials without increasing hardware complexity then the conventional acoustic microscopy systems.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

FIG. 9 is a block diagram of an acoustic microscopy arrangement 900 (same as the acoustic microscopy arrangement 400 of FIG. 4) for determining material property of a sample using edge wavefront signal, in according with an embodiment of the present disclosure. The acoustic microscopy arrangement 900 may be may include a processor 902, a memory 904. These elements may be in direct or indirect communication with each other, for example via one or more buses.

The processor 902 may include a central processing unit (CPU), a digital signal processor (DSP), an application-specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 904 may include a non-transitory computer-readable medium 906. The non-transitory computer-readable medium 906 may include instructions that, when executed by the processor 902, cause the processor 902 to perform the operations described herein with reference to the acoustic microscopy arrangement 400 in connection with embodiments of the present disclosure. Instructions may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, cache memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used herein, the term unit may be implemented in hardware and/or in software. If the unit is implemented in hardware, the unit may be configured as a device, e.g., as a computer or as a processor or as a part of a system, e.g., a computer system. If the unit is implemented in software, the unit may be configured as a computer program product, as a function, as a routine, or as a program code.

The hardware used to implement the various illustrative logics, logical blocks, modules, and circuits described in connection with the aspects disclosed herein may include a general purpose processor, a digital signal processor (DSP), a special-purpose processor such as an application-specific integrated circuit (ASIC) or a field programmable gate array (FPGA), a programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively or additionally, some steps or methods may be performed by circuitry that is specific to a given function.

Many modifications and other embodiments of the inventions set forth herein will come to mind to one skilled in the art to which these inventions pertain having the benefit of teachings presented in the foregoing descriptions and the associated drawings. Although the figures only show certain components of the arrangement and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

1. An acoustic microscopy arrangement (400) for determining material property of a sample using edge wavefront signal, the arrangement comprising:
a curved ultrasonic transducer (402) mounted over top surface of the sample such that the transducer is adjustable in 3 dimensions, wherein the curved ultrasonic transducer is designed without apodization at boundaries;
a pulse generator/receiver (404) operatively coupled to the curved ultrasonic transducer, the pulse generator/receiver configured to provide electrical signal for excitation of the curved ultrasonic transducer; and
a control unit (408) in communication with the curved ultrasonic transducer, the control unit (408) configured to:
generate, using the excited curved ultrasonic transducer (402), an acoustic wavefront signal that includes an edge wavefront signal;
guide the generated acoustic wavefront signal towards the top surface of the sample for a pre-determined period of time and iteratively adjust a defocus distance between the curved ultrasonic transducer and the top layer of the sample;
receive a plurality of reflected acoustic wave signals from the sample for each of the adjusted defocus distance;
generate information for each of the defocus distance based on the plurality of received reflect acoustic wave signals, wherein the information represents amplitude of the plurality of reflected acoustic wave signals and penetration depth of the acoustic wavefront signal within the sample; and
analyze the information for each of the defocus distance to determine the material property of the sample.

2. The arrangement (400) as claimed in claim 1, wherein, in order to analyze the information, the control unit (408) is further configured to:
generate a plurality of curves based on the information, wherein each of the plurality of curves is related to velocity of the reflected acoustic wave signals and the defocus distances;
analyze the generated curve to identify modes related to the acoustic wavefront signal; and
determine the material property of the sample based on the analyzed curved.

3. The arrangement (400) as claimed in claim 2, wherein in order to analyze the information, the control unit (408) is further configured to:
identify the modes related to the acoustic wavefront signal;
compare wave property of modes in the curve with a predefined wave property of modes present in a database of the arrangement (400); and
determine material property of the sample based on the comparison.

4. The arrangement (400) as claimed in claim 1, wherein the control unit (408) is configured to control incident angle of the acoustic wavefront signal of the curved ultrasonic transducer based on the element diameter and focal length of the transducer.

5. The arrangement (400) as claimed in claim 1, further comprising:
a remote pulse unit (406) operatively coupled to the pulse generator/receiver and configured to amplify the electrical signal sent to the curved ultrasonic transducer for excitation.

6. The arrangement (400) as claimed in claim 1, wherein the control unit (408) is further configured to:
generate surface velocity of the sample based the generated plurality of curves.

7. An acoustic microscopy method (800) for determining material property of a sample using edge wavefront signal, the method comprising:
mounting (802) a curved ultrasonic transducer over a top surface of the sample such that the curved ultrasonic transducer is adjustable in 3 dimensions, wherein the curved ultrasonic transducer is designed without apodization at boundaries;
providing (804) electrical signal for excitation of the curved ultrasonic transducer;
generating (806), using the excited curved ultrasonic transducer, an acoustic wavefront signal that includes an edge wavefront signal;
guiding (808) the generated acoustic wavefront signal towards the top surface of the sample for a pre-determined period of time and iteratively adjusting a defocus distance between the curved ultrasonic transducer and the top layer of the sample;
receiving (810) a plurality of reflected acoustic wave signals from the sample for each of the adjusted defocus distance;
generating (814) information for each of the defocus distance based on the plurality of received reflect acoustic wave signals, wherein the information represents amplitude of the plurality of reflected acoustic wave signals and penetration depth of the wavefront signal within the sample; and
analyzing (816) the information for each of the defocus distance to generate the material property of the sample.

8. The method (800) as claimed in claim 7, further comprising:
generating (816) a plurality of curves based on the information, wherein each of the plurality of curves is related to velocity of the reflected acoustic wave signals and the defocus distances;
analyzing (816) the generated curve to identify modes related to the acoustic wavefront signal; and
generating (816) the material property of the sample based on the analyzed curved.

9. The method (800) as claimed in claim 8, further comprising:
identifying (816) the modes related to acoustic wavefront signal;
comparing (816) wave property of modes in the curve with a predefined wave property of modes present in a database; and
determining (816) material property of the sample based on the comparison.

10. The method (800) as claimed in claim 7, further comprising:
controlling incident angle of the acoustic wavefront signal of the curved ultrasonic transducer based on the element diameter and focal length of the transducer.

11. The method (800) as claimed in claim 7, further comprising:
amplifying (804) the electrical signal sent to the curved ultrasonic transducer for excitation.

12. The method (800) as claimed in claim 7, further comprising:
generating (816) surface velocity of the sample based the generated plurality of curves.

13. A non-transitory computer-readable medium (806) that stores instructions, that when executed by one or more processors (802) of an acoustic microscopy arrangement (800), causes the acoustic microscopy arrangement (800) to perform operations comprising:
mounting a curved ultrasonic transducer over a top surface of the sample such that the curved ultrasonic transducer is adjustable in 3 dimensions, wherein the curved ultrasonic transducer is designed without apodization at boundaries;
providing electrical signal for excitation of the curved ultrasonic transducer;
generating, using the excited curved ultrasonic transducer, an acoustic wavefront signal that includes an edge wavefront signal;
guiding the generated acoustic wavefront signal towards the top surface of the sample for a pre-determined period of time and iteratively adjusting a defocus distance between the curved ultrasonic transducer and the top layer of the sample;
receiving a plurality of reflected acoustic wave signals from the sample for each of the adjusted defocus distance;
generating information for each of the defocus distance based on the plurality of received reflect acoustic wave signals, wherein the information represents amplitude of the plurality of reflected acoustic wave signals and penetration depth of the wavefront signal within the sample; and
analyzing the information for each of the defocus distance to generate the material property of the sample.

14. The non-transitory computer-readable medium (806) as claimed in claim 13, further comprising:
generating a plurality of curves based on the information, wherein each of the plurality of curves is related to velocity of the reflected acoustic wave signals and the defocus distances;
analyzing the generated curve to identify modes related to the acoustic edge wavefront signal; and
generating the material property of the sample based on the analyzed curved.

15. The non-transitory computer-readable medium (806) as claimed in claim 14, further comprising:
identifying the modes related to acoustic edge wavefront signal;
comparing wave property of modes in the curve with a predefined wave property of modes present in the database of the system; and
determining material property of the sample based on the comparison.

16. The non-transitory computer-readable medium (806) as claimed in claim 13, further comprising:
controlling incident angle of the acoustic wavefront signal of the curved ultrasonic transducer based on the element diameter and focal length of the transducer.

17. The non-transitory computer-readable medium (806) as claimed in claim 13, further comprising:
amplify the electrical signal sent to the curved ultrasonic transducer for excitation.

18. The non-transitory computer-readable medium (806) as claimed in claim 13, further comprising:
generating surface velocity of the sample based the generated plurality of curves.
